(19) United States
(12) Patent Application Publication
(10) Pub. No.: US 2020/0161047 A1
(43) Pub. Date: May 21, 2020

(54) METHOD FOR PREPARING RARE EARTH PERMANENT MAGNET MATERIAL

(71) Applicant: ADVANCED TECHNOLOGY & MATERIALS CO., LTD., Beijing (CN)

(72) Inventors: Lei Zhou, Beijing (CN); Xinghua Cheng, Beijing (CN); Tao Liu, Beijing (CN); Xiaojun Yu, Beijing (CN)

(21) Appl. No.: 16/605,008

(22) PCT Filed: Mar. 27, 2018
(86) PCT No.: PCT/CN2018/080650

§ 371 Date: Oct. 13, 2019

(30) Foreign Application Priority Data
Apr. 19, 2017 (CN) 201710258413.3

(51) Int. Cl. H01F 41/02; H01F 1/057; B22F 3/24

(52) U.S. Cl. CPC H01F 41/0293; H01F 1/0571; B22F 2301/355; B22F 2003/248; B22F 2003/247; B22F 3/24

(57) ABSTRACT

A method for preparing rare earth permanent magnet material, comprising: firstly weighing powders of three raw materials, H, M and Q, according to the atomic percentage content in general formula H_{100-x-y}MₓQ_{y}, and performing the mixing treatment and sieving treatment in a nitrogen gas or other oxygen-free environments to obtain a composite powder; then machining a sintered NdFeB magnet into a prescribed shape and size, and performing the surface cleaning and drying to obtain a NdFeB magnet to be treated; next, adhering the composite powder to the surface of the NdFeB magnet to be treated by static electricity in an oxygen-free environment; next performing a vacuum thermal treatment and tempering treatment sequentially thereby obtaining the rare earth permanent magnet material. For the above method, the efficiency is high and binding force between the heavy rare earth element attachments and the substrate magnet is strong, it is convenient for the residual powder materials to be recycled. The coercivity of the prepared NdFeB magnet can be increased by 4000-14000 Oe, the remanence is only reduced by 1-2%, and the magnet with equivalent performance can be saved 30% of the heavy rare earth usage amount.

### FIELD OF THE APPLICATION

The present invention relates to a method for preparing rare earth permanent magnet material, and particularly relates to a method in which one or more compounds rich in heavy rare earths and pure metal powders are adhered on the surface of sintered NdFeB magnet using static electricity, and high temperature treatment and low temperature aging are performed to improve the performance of the magnet, which belongs to the technical field of rare earth permanent magnet material.

### BACKGROUND OF THE APPLICATION

NdFeB permanent magnet materials are widely used in the fields of hybrid electric vehicle, wind power generation, energy-saving motor and inverter air conditioner and the like. In these fields, magnets are required to work at high temperature for a long time, and rare earth permanent magnets should have higher coercivity Hcj. Conventionally, an effective method for improving the coercivity Hcj of NdFeB sintered magnets is to replace Nd in Nd₂Fe₁₄B which is the main phase of the magnet by heavy rare earth elements such as dysprosium (Dy) and terbium (Tb) to form (Nd, Dy) ₂Fe₁₄B. The anisotropy of (Nd, Dy)₂Fe₁₄B is stronger than that of Nd₂Fe₁₄B, so the Hcj of the magnet is significantly improved. However, these heavy rare earth elements are scarce and expensive. On the other hand, the magnetic moments of Nd and iron are arranged in parallel, while that of Dy and iron are arranged in antiparallel. Therefore, the remanence Br and the maximum magnetic energy product (BH)max of the magnet will be decreased.

In recent years, many research institutes have reported various processes for diffusing rare earth elements from the surface of the magnet to the interior of the substrate. These processes allow the infiltrated rare earth elements pass along the grain boundaries and the main phase grain surface area, so that the rare earth elements can be optimally distributed, which not only improves the coercivity, but also saves the usage amount of precious rare earths, and the remanence and magnetic energy product haven't any significant reduction. At present, the researches on improving the performance of magnet utilizing the principle of grain boundary diffusion have been making for more than ten years at home and abroad. The grain boundary diffusion treatment technology mainly uses coating, deposition, plating, sputtering, adhesion and the like to adhere metal powders (such as Dy, Tb or other rare earth elements) or compounds to the outer surface of the magnet, and the metal powders or the compounds are diffused into the main phase of the sintered magnet via the grain boundary diffusion by the thermal treatment. This grain boundary diffusion technique has a significant effect on the composition, microstructure and magnetic properties of the sintered NdFeB magnet However, in these researches, there are still some problems to be solved urgently: (1) The method of adhering Dy/Tb to the surface of the NdFeB sintered magnet by sputtering has defects such as low productivity, high process cost, and easily forming melting pit and the like. During the evaporation process, a large number of rare earth metals are dispersed in the chamber of heating furnace, which causes unnecessary waste of heavy rare earth metals. (2) The method of vapor phase precipitation is used and has the disadvantages of low utilization rate of heavy rare earth elements and high processing temperature. (3) Rare earth oxides or fluorides are coated on the surface, heated and diffused, having a problem that there is a limitation on the increase of coercivity. (4) In addition, how to the make most efficient use of Dy/Tb resources is also a key issue in such technologies as Dy/Tb is expensive.

### SUMMARY

Aiming at the defects of existing technology, one object of the present invention is to provide a method for preparing rare earth permanent magnet material. In this method, one or more compounds rich in heavy rare earth elements and other pure metal powders are electrostatically adhered to the surface of the NdFeB substrate, are sintered at a high temperature to prepare a rare earth permanent magnet material. This method not only realizes the ordered arrangement of the rare earth elements on the surface and inside of the NdFeB substrate but also increases the coercivity of the magnet, meanwhile, the remanence is not significantly reduced substantially.

In order to achieve the above-mentioned object, the following technical solution is used in the present invention.

a method for preparing rare earth permanent magnet material comprises: step 1, weighing powders of three raw materials H, M and Q, according to the atomic percentage contents in general formula H_{100-x-y}MₓQ_{y}, and performing the mixing treatment and sieving treatment sequentially on the three raw materials in nitrogen or other oxygen-free environments to obtain a composite powder; in the general formula, H is one or more in fluoride or oxide powder of Dy, Tb, DyTb, Ho and Gd, M is Nd or/and Pr metal powder(s), and Q is one or more in Cu, Al, Zn, Ga and Sn metal powders, x and y are respectively the atomic percentage contents of the raw material M and the raw material Q, x=0-20 (such as 0, 1, 3, 5, 7, 9, 11, 13, 15, 17, 19), y=0-40 (such as 0, 1, 3, 5, 7, 8, 9, 11, 13, 15, 17, 19, 20, 23, 28, 30, 34, 37, 39) and x and y are not zero at the same time; step 2, machining a sintered NdFeB magnet into a prescribed shape and size, and then performing the surface cleaning and drying to obtain a NdFeB magnet to be treated; step 3, adhering the composite powder to the surface of the NdFeB magnet to be treated by static electricity in an oxygen-free environment to obtain a NdFeB magnet, the surface of which is adhered with.

step 4, performing vacuum thermal treatment on the NdFeB magnet, the surface of which is adhered with, and then furnace cooling to obtain a diffused NdFeB magnet.

step 5, performing tempering treatment (i.e., aging treatment) on the diffused NdFeB magnet to obtain the rare earth permanent magnet material.

The technical principle of the present invention is to improve the performance of the magnet by means of electrostatic adhesion, grain boundary diffusion treatment and subsequent tempering treatment. Wherein, a powder film having a strong binding force and formed by the compounds rich in heavy rare earth elements and pure metal powders can be formed on the surface of the sintered NdFeB magnet by means of electrostatic adhesion. The compounds rich in heavy rare earth elements and pure metal powders are adhered to the surface of the magnet by electrostatic action, and grain boundary diffusion is achieved by subsequent thermal treatment, thereby increasing the coercivity characteristic of the magnet.

The role of the H component is mainly to provide heavy rare earth elements for subsequent treatment, and to improve the magnetic property of the magnet by element substitution.

The main role of the M component is twofold: on the one hand, the heavy rare earth in the heavy rare earth compound powders is reduced at a high temperature to form a heavy earth metal elementary substance; on the other hand, the number of intergranular phases in the grain boundary diffusion procedure of the magnet is increased, which contributes to increase efficiency. When the content of M is 0, the replacement and substitution of the heavy rare earth will require a more complicated form to achieve, for example, a reducing agent is added and the reducing agent cannot affect the performance of the magnet, or the neodymium-rich phase in the magnet reacts with the heavy rare earth. When the atomic percentage of M is greater than 20, it will cause waste and also reduce the diffusion effect. Here, M is Nd, Pr or PrNd (i.e., a mixed powder of two metals of Pr and Nd, of which the mass ratio is preferably 1:2-1:5, such as 1:2, 1:2.5, 1:3, 1:4, 1:4.5, 1:5).

The heavy rare earth after replacement needs to diffuse from the surface layer of the magnet to the core. The fluidity and wettability of the liquid phase are important, which is significant for the diffusion results and efficiency. The main role of the Q component is to increase the fluidity and wettability of the heavy rare earth elements after being replaced, so as to enhance the diffusion efficiency. When the atomic percentage content of Q is greater than 40, the concentration of the heavy rare earth elements in the flowing liquid phase is diluted, which is disadvantageous for the improvement in the performance of the magnet and the diffusion effect instead.

In the above-mentioned method, as one preferred embodiment, in the step 1, x is 1-15, y is 4-25 in the general formula.

In the above-mentioned method, as one preferred embodiment, in the step 1, M is PrNd metal powder (i.e., a mixed powder of Pr and Nd two metals), and the mass ratio of Pr and Nd is 1:2-1:5 (such as 1:2, 1:2.5, 1:3, 1:4, 1:4.5 and 1:5). In the above-mentioned method, as one preferred embodiment, in the step 1, the raw material powders have a particle size of −150 mesh, and the sieving treatment means sieving with a 150 mesh sieve. As the particle size of the powder is smaller and less than 150 mesh and it is possible for a small part to aggregate during mixing, and thus sieving needs to be performed after mixing. The process of mixing powder may be a conventional process in the art, such as mixing powder by 360° rotation using a common mixing equipment at present.

In the above-mentioned method, as one preferred embodiment, in the step 2, the thickness of the NdFeB magnet to be treated in direction of orientation is 1-8 mm (such as 2 mm, 3 mm, 4 mm, 5 mm, 6 mm, 7 mm). If the thickness is too small, the magnet is prone to bending deformation in the subsequent treatment. And if the thickness is too large, the effect of the grain boundary diffusion cannot reach the core of the magnet, resulting in a large difference between internal and external performance.

In the above-mentioned method, as one preferred embodiment, in the step 2, the procedure of the surface cleaning is as follows: firstly placing the sintered NdFeB magnet in a degreasing tank and soaking for 8-15 minutes (such as 10 min, 12 min and 14 min) to remove oil stain on the surface of the magnet; then performing the first water washing, acid pickling, the second water washing and ultrasonic treatment sequentially, finally, air drying the surface of the sintered NdFeB magnet. Preferably, the acid pickling is performed with a dilute HNO₃ (mass fraction concentration of 50-70%) and the time thereof is 20-45 s (such as 22 s, 28 s, 35 s, 39 s and 44 s), and the time of the ultrasonic treatment is 20-45 s (such as 22 s, 28 s, 35 s, 39 s and 44 s), the air drying is fast drying using strong wind.

In the above-mentioned method, as one preferred embodiment, in the step 3, the thickness of the composite powder film is 10-40 ρm (such as 12 μm, 15 μM, 20 μM, 25 μm, 30 μm, 35 μm and 38 μm). The films with a thickness greater than 40 μm have poor adhesion, and the effect of the grain boundary diffusion has already reached the best below 40 μm and a larger thickness is not helpful for performance improvement. If it is too small, the ability to improve performance is limited. More preferably, the thickness of the composite powder film is 25-40 μm (such as 26 μm, 28 μm, 32 μm, 36 μm and 39 μm).

In the prior art, the powder containing the curing agent is adhered to the surface of the workpiece using static electricity generally, which plays the role of protecting the surface of the workpiece after low temperature curing. If the electrostatic powder does not contain the curing agent for curing, the powder is difficult to adhere to the surface of the workpiece for a long time, cannot play the role of protecting the workpiece. However, the raw material powder for improving the performance of the permanent magnet material in the present invention cannot contain a curing agent (if it is contained, there is an adverse effect on the subsequent high temperature treatment), and also there is no curing process, so it is critical and difficult to control the adhesive force of the composite powder on the surface of the magnet and film-forming thickness. The composite powder is sprayed onto the surface of the NdFeB magnet to be treated using an electrostatic spray gun as the inventor controls the parameters such as voltage, time and the like. A film layer with a suitable thickness is obtained, and the adhesive force is good.

In the above-mentioned method, as one preferred embodiment, in the step 3, the composite powder is sprayed onto the surface of the NdFeB magnet to be treated by electrostatic spray gun. That is, the composite powder is carried with positive or negative electrons by the spray gun, which accelerate and strike on the NdFeB magnet to be treated that is connected to the cathode or the anode. Wherein, technological conditions are shown as follows.

The voltage is 30-120 kv (such as 35 kv, 40 kv, 50 kv, 60 kv, 70 kv, 80 kv, 90 kv, 100 kv, 110 kv and 115 kv), providing the electromotive force between positive and negative ions. If the voltage is too low, the particle impact force of the powder is weak and the adhesion is poor. If the voltage is too high, a higher corona current will be generated between the workpiece and the nozzle, and the safety is poor. More preferably, it is 50-90 kv.

The time is 5-40 s (such as 8 s, 12 s, 16 s, 20 s, 25 s, 30 s, 35 s and 38 s). When the time is too short, the adhered powder is less, and the film thickness is small. When the time is too long, as the adhered powder reaches a certain thickness and no more powder (required for subsequent effects) is needed, and the adhesion between the powders becomes poor. More preferably, it is 15-30 s.

The movement speed of spray gun is 5-45 cm/s (such as 6 cm/s, 8 cm/s, 10 cm/s, 15 cm/s, 20 cm/s, 25 cm/s, 30 cm/s, 35 cm/s, 40 cm/s and 42 cm/s). If the speed is too fast, the adhesion of the powder is uneven. If the speed is too slow, the waste of powder is serious. More preferably, it is 10-30 cm/s.

The spray distance is 8-35 cm (such as 10 cm, 12 cm, 15 cm, 18 cm, 22 cm, 24 cm, 25 cm and 28 cm). If the spray distance is too short, the safety is poor, as the spray gun is used to bring out the powder by the airflow, which has an impact on the adhered powder. If the spray distance is too far, the distance that the powder flies becomes far, and both the adhesive rate and adhesive force will be reduced. And the efficiency is reduced and the cost is increased. More preferably, it is 15-25 cm. An electrostatic spray gun is used in the present application and the quality, thickness and cost of the formed film are influenced by controlling the above parameters (voltage, time, movement speed of spray gun, and spray distance), finally, the composite powder is sprayed onto the surface of the NdFeB magnet to be treated. The film layer having suitable thickness and good adhesive force is obtained, meanwhile, the cost of production is reduced.

In the above-mentioned method, as one preferred embodiment, in the step 4, the conditions of the vacuum thermal treatment are shown as follows. The vacuum degree is higher than 10⁻³ Pa (such as 5×10⁻⁴ Pa, 1×10⁻⁴ Pa, 8×10⁻⁵ Pa, 5×10⁻⁵ Pa and 1×10⁻⁶ Pa), the holding temperature is 650-1050° C. (such as 650° C., 700° C., 750° C., 800° C., 850° C., 900° C., 1000° C. and 1020° C.), and the holding time is 5-50 h (such as 6 h, 10 h, 20 h, 30 h, 40 h and 48 h). If the holding temperature is too low, the treatment effect is not obvious. If the holding temperature is too high, the grain will grow up abnormally, and the magnetic properties will deteriorate instead. The matching of the temperature and time will help to play a good treatment effect as well as use energy sources effectively. More preferably, in the step 4, the holding temperature is 830-870° C. (such as 835° C., 840° C., 845° C., 850° C., 855° C., 860° C. and 865° C.), and the holding time is 30-40 h (such as 32 h, 34 h, 36 h and 38 h).

In the above-mentioned method, as one preferred embodiment, in the step 4, the furnace cooling is performed until the temperature is no more than 50° C. (such as 25° C., 30° C., 35° C., 40° C. and45° C.). If being removed from furnace at above 50° C., on the one hand, the magnet is easy to absorb the moisture and the like in the surrounding environment in the hot state, which is adverse for the magnetic properties. On the other hand, it is not conducive to heating components in the furnace body, and the useful life is reduced. And the physical characters after partial oxidation have also changed, resulting in that the temperature distribution in the furnace body is changed.

In the above-mentioned method, as one preferred embodiment, in the step 5, the temperature of the tempering treatment is 420-640° C. (such as 430° C., 460° C., 500° C., 550° C., 600° C. and 630° C.), and the time is 2-10 h (such as 3 h, 4 h, 6 h, 8 h and 9 h). Under this tempering system, it is good for formation and maintenance of neodymium-rich grain boundary phase. And the performance of the product will be reduced when not falling into this temperature range. More preferably, in the step 5, the temperature of the tempering treatment is 420-480° C. (such as 425° C., 430° C., 445° C., 455° C. and 470° C.), and the time thereof is 4-6 h (such as 4.5 h, 5 h and 5.5 h).

In the above-mentioned method, a treatment device in the step 4 may be a vacuum thermal treatment furnace.

In the above-mentioned method, as a preferred embodiment, after the step 5, an aftertreatment step is further included, which comprises: soaking the rare earth permanent magnet material in dilute nitric acid to remove residual attachments on the surface, and then cleaning the rare earth permanent magnet material with a deionized water. Preferably, the dilute nitric acid is a solution of nitric acid in alcohol, and the mass concentration is 2-10% (3%, 4%, 5%, 6%, 7%, 8% and 9%). If the concentration is too high, the window of time matching will be very small, the possibility of residue will increase. If the concentration is low, the efficiency will be decreased. More preferably, the mass concentration is 4-6%, the time of the soaking is 60-180 s (such as 65 s, 70 s, 85 s, 100 s, 120 s, 145 s, 160 s, 170 s and 175 s). After the tempering treatment, the residual attachments on the surface of the magnet are non-magnetic, which will affect the performance of the magnet. The above-mentioned aftertreatment is performed to remove this layer of substance and a magnet with further improved performance can be obtained, and the time of the soaking is related to the film thickness.

Compared with the prior art, the present invention has the following beneficial effects:

1) The NdFeB substrate are well combined with the compounds rich in heavy rare earth elements and the pure metal powders by the method of electrostatic adhesion. After the high temperature treatment, the heavy rare earth compound and the pure metal powders in the powder film diffuse into the border region between the main phase and the neodymium-rich phase and gather in the magnet. The coercivity of the NdFeB magnets after these treatments is significantly improved, which reaches or exceed the effects of methods such as evaporation, sputtering and the like. The preparation method provided in the present invention improves the physical properties of the grain boundary phase and the adjacent region by the effective adhesion of the composite powder, the suitable thermal treatment temperature and time, and effective aging temperature and time, so that the performance of the magnet is significantly improved, meanwhile, the usage amount of heavy rare earths is saved greatly. While the conventional method mainly adopts the way of adding the heavy rare earths to increase the coercivity. For this way, the remanence is greatly reduced on the one hand and a large amount of heavy rare earths are present in the main phase particles on the other hand, so more usage amounts of heavy rare earths are needed. The coercivity of the rare earth permanent magnet material NdFeB magnet prepared by the preparation method provided in the invention can be increased by 4000-14000 Oe, the remanence is only reduced by 1-2%, and the magnet with equivalent performance can save 30% of the heavy rare earth usage amount.

2) The raw materials required for conventional evaporation and sputtering are pure metals, which are relatively expensive compared with the fluoride or oxide powder used in the present invention. That is, the raw materials used in the present invention are compounds rich in heavy rare earth elements (fluoride or oxide), which are a semi-finished product before metal reduction, has low price and are easy to obtain. The adhesions in the conventional evaporation and sputtering processes are both a simple physical adhesion process, and requires certain temperature and vacuum conditions. However, in the present invention, for the method of electrostatic adhesion, binding force between powder and substrate is stronger as powder and workpiece have different charges. Moreover, once the electrostatic adhesion process is over, it can be reused after cleaning. Furthermore, the electrostatic adhesion can be performed at normal temperature, and only nitrogen gas protection is required. Therefore, the present invention opens up a novel route for improving the performance of the rare earth permanent magnet material NdFeB. The invention is used to improve the performance of the magnet. On the one hand, the efficiency is high and binding force between the heavy rare earth element attachments and the substrate magnet is strong. On the other hand, the residual powder material is convenient to be recycled, the amount of heavy rare earth used is greatly reduced, the cost of the product is reduced, which make the price/performance ratio of the product have more advantages.

### BRIEF DESCRIPTION OF THE DRAWINGS

FIG. 1 is a technique flowchart of a preferred embodiment in the present invention.

FIG. 2 is a structural diagram of a rare earth permanent magnet material prepared in Example 1 of the present invention.

FIG. 3 is a variation diagram of magnetic performance of magnets before and after treatment in Example 1 of the present invention, of which the abscissa is Applied Field which is the external magnetic field intensity, and the ordinate is Magnetisation which is the magnetization intensity.

### DETAILED DESCRIPTION OF THE EMBODIMENTS

The present invention will be described further in detail below by examples in combination with the accompanying drawings in order to make the present invention more easily to understand clearly. The NdFeB magnet to be treated used in the following examples are all sintered NdFeB magnets. In each example, different brands and different batches of commercial sintered NdFeB magnet are used as the magnet to be treated, and the method in the present invention is applicable to various NdFeB magnets. The equipment used for electrostatic adhesion is electrostatic powder spray line. The manufacturer is Gu'anKeyuXinpeng Automation Control Equipment Co., Ltd., the electrostatic spray gun being the core part uses the spray gun of German Wagner.

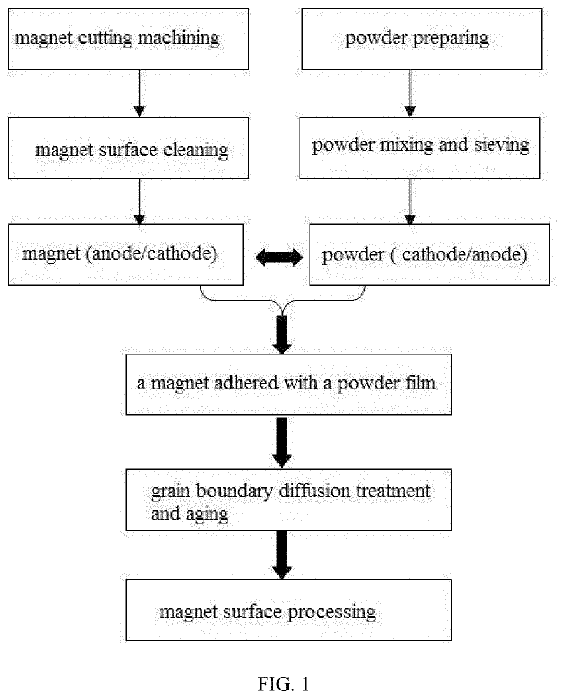

FIG. 1 shows a process flow of one preferred embodiment of the method in the present invention, which specifically comprises the steps of: magnet cutting machining, magnet surface cleaning; powder preparing, powder mixing and sieving; preparing a magnet adhered with a powder film by electrostatic adhesion; grain boundary diffusion treatment and aging; magnet surface processing. Specific examples are given below.

### EXAMPLE 1

(1) The composite powder was formulated in accordance with the powder ratio formula (TbF₃)₉₅Nd₂Al₃. TbF₃ powder with particle size of −150 mesh, metal Nd powder with particle size of −150 mesh and metal Al powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 50H brand was machined into a shape to be treated, of which the thickness in the direction of orientation is 1.96 mm. Then the procedure of cleaning surface was entered, and the procedure of cleaning surface was shown as follows: the magnet was placed in the degreasing tank and was soaked for 10 min to remove the oil stain on the surface of the magnet. The surface was washed to clean with water, and then it was acid pickled with dilute HNO₃ (concentration is 50 wt %) for 20 s. Then it was washed with water again and was treated by ultrasonic wave for 20 s, and the surface of the magnet was quickly dried by strong wind, thereby obtaining a NdFeB magnet to be treated.

(3) In a nitrogen atmosphere, the composite powder prepared in step (1) was carried with positive electrons by a spray gun according to technological conditions that a voltage was 70 kV, a time was 30 s, a moving speed of the spray gun was 20 cm/s and a spray distance was 20 cm. It was accelerated and impacted onto the NdFeB magnet to be treated obtained in step (2) which was connected to the cathode, thereby obtaining a NdFeB magnet with the composite powder film adhered to the surface thereof, and the thickness of the film was about 40 μm.

(4) The NdFeB magnet with composite powder film adhered to the surface thereof obtained in step (3) was placed in a vacuum thermal treatment furnace with a vacuum degree higher than 10⁻³ Pa and was maintained at 850° C. for 35 hours. It was cooled inside the furnace to not higher than 50° C., and then tempering treatment was performed at 490° C. for 6 hours.

(5) The magnet obtained in step (4) was soaked in dilute nitric acid (the concentration was 6 wt %) for 80 s to remove residual attachments on the surface of the magnet. The magnet was cleaned with deionized water to obtain a magnet with improved performance.

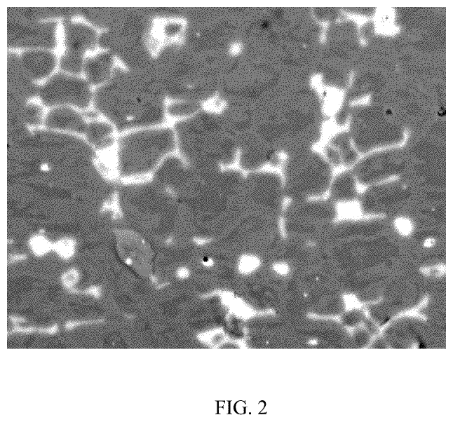

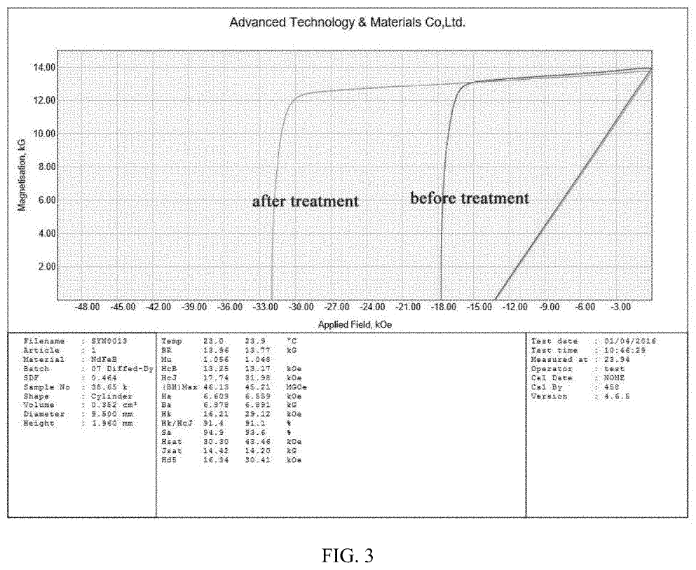

The coercivity of the rare earth permanent magnet material prepared in this example is increased by 14240 Oe, the remanence is slightly reduced and is reduced by 190 Gs. The performance variation of the magnet before and after the treatment (that is, the NdFeB magnet to be treated obtained in the step (2) and the permanent magnet finally obtained after the treatment in the steps (3), (4) and (5) were performed the performance test, and so were the subsequent examples) are shown in Table 1. The microstructure of the rare earth permanent magnet material prepared in this embodiment is shown in FIG. 2. It can be seen from the figure that a uniform and continuous grain boundary phase is coated around the main phase particles, which will greatly improve the demagnetization coupling ability of the magnet in the external magnetic field and is beneficial to the improvement of the coercivity of the magnet. FIG. 3 is a variation diagram of magnetic performance before and after treatment in the example 1 of the present invention. It can be seen from the diagram that coercivity of sintered NdFeB is increased from 17740 Oe to 31980 Oe, that is, increased by 14240 Oe, and the remanence is slightly reduced and is reduced from 13960 Gs to 13770 Gs, that is, reduced by 190 Gs by the technical treatment of steps (3), (4) and (5) in this example.

### EXAMPLE 2

(1) The composite powder was formulated in accordance with the powder ratio formula (DyF₃)₉₅Nd₁Al₄. DyF₃ powder with particle size of −150 mesh, metal Nd powder with particle size of −150 mesh and metal Al powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 48H brand was machined into a shape to be treated, of which the thickness in the direction of orientation was 3 mm Then the procedure of cleaning surface was entered, and the procedure of cleaning surface was as shown as follows: the magnet was placed in the degreasing tank and was soaked for 10 min to remove the oil stain on the surface of the magnet. The surface was washed to clean with water, and then it was acid pickled with dilute HNO₃ for 20 s. Then it was washed with water again and was treated by ultrasonic wave for 20 s, and the surface of the magnet was quickly dried by strong wind, thereby obtaining a NdFeB magnet to be treated.

(3) In a nitrogen atmosphere, the composite powder prepared in step (1) was carried with positive electrons by a spray gun according to technological conditions that a voltage was 60 kV, a time was 25 s, a moving speed of the spray gun was 20 cm/s and a spray distance was 20 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 30 μm.

(4) The NdFeB magnet with composite powder film adhered to the surface obtained in step (3) was placed in a vacuum thermal treatment furnace with a vacuum degree higher than 10⁻³ Pa and was maintained at 830° C. for 30 hours. It was cooled inside the furnace to not higher than 50° C., and then tempering treatment was performed at 510° C. for 4 hours.

(5) The magnet obtained in step (4) was soaked in dilute nitric acid (the concentration was 5.5 wt %) for 60 s to remove residual attachments on the surface of the magnet. The magnet was cleaned with deionized water to obtain a magnet with improved performance.

The coercivity of the rare earth permanent magnet material prepared in this example is increased by 7500 Oe, the remanence is slightly reduced and is reduced by 175 Gs. The performance variation of the magnet before and after the treatment are shown in Table 1.

### EXAMPLE 3

(1) The composite powder was formulated in accordance with the powder ratio formula (TbF₃)₉₅Cu₅. TbF₃ powder with particle size of −150 mesh and metal Cu powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 42M brand was machined into a shape to be treated, of which the thickness in the direction of orientation was 5 mm Then the procedure of cleaning surface was entered, and the procedure of cleaning surface was shown as follows: the magnet was placed in the degreasing tank and was soaked for 10 min to remove the oil stain on the surface of the magnet. The surface was washed with water, and then it was acid pickled with dilute HNO₃ for 35 s. Then it was washed with water again and was treated by ultrasonic wave for 35 s, and the surface of the magnet was quickly dried by strong wind, thereby obtaining a NdFeB magnet to be treated.

(3) In a nitrogen atmosphere, the composite powder prepared in step (1) was carried with positive electrons by a spray gun according to technological conditions that a voltage was 60 kV, a time was 25 s, a moving speed of the spray gun was 20 cm/s and a spray distance was 20 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 30 μm.

(4) The NdFeB magnet with composite powder film adhered to the surface obtained in step (3) was placed in a vacuum thermal treatment furnace with a vacuum degree higher than 10⁻³ Pa and was maintained at 860° C. for 35 hours. It was cooled inside the furnace to not higher than 50° C., and then tempering treatment was performed at 500° C. for 6 hours.

(5) The magnet obtained in step (4) was soaked in dilute nitric acid (the concentration was 6.5 wt %) for 100 s to remove residual attachments on the surface of the magnet. The magnet was cleaned with deionized water to obtain a magnet with improved performance.

The coercivity of the rare earth permanent magnet material prepared in this example is increased by 12000 Oe, the remanence is slightly reduced and is reduced by 180 Gs. The performance variation of the magnet before and after the treatment are shown in Table 1.

### EXAMPLE 4

(1) The composite powder was formulated in accordance with the powder ratio formula(HoF₃)₉₇Pr₁Cu₂. HoF₃ powder with particle size of −150 mesh, metal Pr powder with particle size of −150 mesh and metal Cu powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 42M brand was machined into a shape to be treated, in which the thickness in the direction of orientation was 3 mm. Then the procedure of cleaning surface was entered, and the procedure of cleaning surface was shown as follows. The magnet was placed in the degreasing tank and was soaked for 10 min to remove the oil stain on the surface of the magnet. The surface was washed to clean with water, and then it was acid pickled with dilute HNO₃ for 25 s. Then it was washed with water again and was treated by ultrasonic wave for 25 s, and the surface of the magnet was quickly dried by strong wind, thereby obtaining a NdFeB magnet to be treated.

(3) In a nitrogen atmosphere, the composite powder prepared in step (1) was carried with positive electrons by a spray gun according to technological conditions that a voltage was 50 kV, a time was 15 s, a moving speed of the spray gun was 25 cm/s and a spray distance was 20 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 25 μm.

(4) The NdFeB magnet with composite powder film adhered to the surface obtained in step (3) was placed in a vacuum thermal treatment furnace with a vacuum degree higher than 10⁻³ Pa and was maintained at 850° C. for 35 hours. It was cooled inside the furnace to not higher than 50° C., and then tempering treatment was performed at 480° C. for 4 hours.

(5) The magnet obtained in step (4) was soaked in dilute nitric acid (the concentration was 5.5 wt %) for 60 s to remove residual attachments on the surface of the magnet. The magnet was cleaned with deionized water to obtain a magnet with improved performance.

The coercivity of the rare earth permanent magnet material prepared in this example is increased by 4000 Oe, the remanence is slightly reduced and is reduced by 210 Gs. The performance variation of the magnet before and after the treatment are shown in Table 1.

### EXAMPLE 5

(1) The composite powder was formulated in accordance with the powder ratio formula ((DyTb)F₃)₉₆Cu₁Al₃. (DyTb)F₃ powder with particle size of −150 mesh, metal Cu powder with particle size of −150 mesh and metal Al powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 52SH brand was machined into a shape to be treated, in which the thickness in the direction of orientation is 6 mm. Then the procedure of cleaning surface was entered, and the procedure of cleaning surface was shown as follows. The magnet was placed in the degreasing tank and was soaked for 10 min to remove the oil stain on the surface of the magnet. The surface was washed to clean with water, and then it was acid pickled with dilute HNO₃ for 45 s. Then it was washed with water again and was treated by ultrasonic wave for 45 s, and the surface of the magnet was quickly dried by strong wind, thereby obtaining a NdFeB magnet to be treated.

(3) In a argon atmosphere, the composite powder prepared in step (1) was carried with positive electrons by a spray gun according to technological conditions that a voltage was 65 kV, a time was 28 s, a moving speed of the spray gun was 20 cm/s and a spray distance was 18 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 30 μm.

(4) The NdFeB magnet with composite powder film adhered to the surface obtained in step (3) was placed in a vacuum thermal treatment furnace with a vacuum degree higher than 10⁻³ Pa and was maintained at 870° C. for 40 hours. It was cooled inside the furnace to not higher than 50° C., and then tempering treatment was performed at 520° C. for 6 hours.

(5) The magnet obtained in step (4) was soaked in dilute nitric acid (the concentration was 6 wt %) for 90 s to remove residual attachments on the surface of the magnet. The magnet was cleaned with deionized water to obtain a magnet with improved performance.

The coercivity of the rare earth permanent magnet material prepared in this example is increased by 11000 Oe, the remanence is slightly reduced and is reduced by 168 Gs. The performance variation of the magnet before and after the treatment are shown in Table 1.

### Example 6

(1) The composite powder was formulated in accordance with the powder ratio formula (GdF₃)₉₈Cu₂. GdF₃ powder with particle size of −150 mesh and metal Cu powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 35M+ brand was machined into a shape to be treated, in which the thickness in the direction of orientation was 3 mm Then the procedure of cleaning surface was entered, and the procedure of cleaning surface was shown as follows. The magnet was placed in the degreasing tank and was soaked for 10 min to remove the oil stain on the surface of the magnet. The surface was washed to clean with water, and then it was acid pickled with dilute HNO₃ for 25 s. Then it was washed with water again and was treated by ultrasonic wave for 25 s, and the surface of the magnet was quickly dried by strong wind, thereby obtaining a NdFeB magnet to be treated.

(3) In a argon atmosphere, the composite powder prepared in step (1) was carried with positive electrons by a spray gun according to technological conditions that a voltage was 65 kV, a time was 25 s, a moving speed of the spray gun was 20 cm/s and a spray distance was 20 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 35 μm.

(4) The NdFeB magnet with composite powder film adhered to the surface obtained in step (3) was placed in a vacuum thermal treatment furnace with a vacuum degree higher than 10⁻³ Pa and was maintained at 840° C. for 35 hours. It was cooled inside the furnace to not higher than 50° C., and then tempering treatment was performed at 490° C. for 4 hours.

(5) The magnet obtained in step (4) was soaked in dilute nitric acid (the concentration was 5 wt %) for 60 s to remove residual attachments on the surface of the magnet. The magnet was cleaned with deionized water to obtain a magnet with improved performance.

The coercivity of the rare earth permanent magnet material prepared in this example is increased by 4200 Oe, the remanence is slightly reduced and is reduced by 208 Gs. The performance variation of the magnet before and after the treatment are shown in Table 1.

### EXAMPLE 7

(1) The composite powder was formulated in accordance with the powder ratio formula (TbO₃)₉₄Nd₁Al₅. TbO₃ powder with particle size of −150 mesh, metal Nd powder with particle size of −150 mesh and metal Al powder with particle size of −150 mesh were weighted. The above powders were mixed to be even, and were sieved through 150 mesh. The processes of powder mixing and sieving were needed to perform under a nitrogen atmosphere.

(2) Firstly, sintered NdFeB magnet of commercial 48H+ brand was machined into a shape to be treated, in which the thickness in the direction of orientation was 8 mm. Then the procedure of cleaning surface was entered, and the procedure of cleaning surface was shown as follows. The magnet was placed in the degreasing tank and was soaked for 10 min to remove the oil stain on the surface of the magnet. The surface was washed to clean with water, and then it was acid pickled with dilute HNO₃ for 45 s. Then it was washed with water again and was treated by ultrasonic wave for 45 s, and the surface of the magnet was quickly dried by strong wind, thereby obtaining a NdFeB magnet to be treated.

(3) In a argon atmosphere, the composite powder prepared in step (1) was carried with positive electrons by a spray gun according to technological conditions that a voltage was 75 kV, a time was 30 s, a moving speed of the spray gun was 20 cm/s and a spray distance was 20 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 40 μm.

(4) The NdFeB magnet with composite powder film adhered to the surface obtained in step (3) was placed in a vacuum thermal treatment furnace with a vacuum degree higher than 10⁻³ Pa and was maintained at 860° C. for 40 hours. It was cooled inside the furnace to not higher than 50° C., and then tempering treatment was performed at 490° C. for 5 hours.

(5) The magnet obtained in step (4) was soaked in dilute nitric acid (the concentration was 8 wt %) for 180 s to remove residual attachments on the surface of the magnet. The magnet was cleaned with deionized water to obtain a magnet with improved performance.

The coercivity of the rare earth permanent magnet material prepared in this example is increased by 8000 Oe, the remanence is slightly reduced and is reduced by 185 Gs. The performance variation of the magnet before and after the treatment are shown in Table 1.

### EXAMPLE 8

(1) The composite powder was formulated in accordance with the powder ratio formula (DyO₃)₉₇(PrNd)₂Al₁. DyO₃ powder with particle size of −150 mesh, metal PrNd powder (the mass ratio of Pr to Nd is 1:4) with particle size of −150 mesh and metal Al powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 42M brand was machined into a shape to be treated, in which the thickness in the direction of orientation was 6 mm. Then the procedure of cleaning surface was entered, and the procedure of cleaning surface was shown as follows. The magnet was placed in the degreasing tank and was soaked for 10 min to remove the oil stain on the surface of the magnet. The surface was washed to clean with water, and then it was acid pickled with dilute HNO₃ for 45 s. Then it was washed with water again and was treated by ultrasonic wave for 45 s, and the surface of the magnet was quickly dried by strong wind, thereby obtaining a NdFeB magnet to be treated.

(3) In a argon atmosphere, the composite powder prepared in step (1) was carried with positive electrons by a spray gun according to technological conditions that a voltage was 75 kV, a time was 30 s, a moving speed of the spray gun was 18 cm/s and a spray distance was 22 cm. It was accelerated and impacted onto the NdFeB magnet to be treated obtained in step (2) which was connected to the cathode, thereby obtaining a NdFeB magnet with composite powder film adhered to the surface there, and the thickness of the film was about 40 μm.

(4) The NdFeB magnet with composite powder film adhered to the surface obtained in step (3) was placed in a vacuum thermal treatment furnace with a vacuum degree higher than 10⁻³ Pa and was maintained at 830° C. for 40 hours. It was cooled inside the furnace to not higher than 50° C., and then tempering treatment was performed at 490° C. for 6 hours.

(5) The magnet obtained in step (4) was soaked in dilute nitric acid (the concentration was 7 wt %) for 120 s to remove residual attachments on the surface of the magnet. The magnet was cleaned with deionized water to obtain a magnet with improved performance.

The coercivity of the rare earth permanent magnet material prepared in this example is increased by 6500 Oe, the remanence is slightly reduced and is reduced by 190 Gs. The performance variation of the magnet before and after the treatment are shown in Table 1.

### EXAMPLE 9

(1) The composite powder was formulated in accordance with the powder ratio formula (TbF₃)₄₆(DyO₃)₄₈Nd₂ZnSnCu₂. TbF₃ and DyO₃ powder with particle size of −150 mesh, metal Nd powder with particle size of −150, metal Zn, Sn and Cu powder with particle size of −150 mesh were weighted. The above powders were mixed to be even, and were sieved through 150 mesh. The processes of powder mixing and sieving were performed under a nitrogen atmosphere.

(2) Firstly, sintered NdFeB magnet of commercial 46UH brand was machined into a shape to be treated, of which the thickness in the direction of orientation was 4.5 mm. Then the procedure of cleaning surface was entered, and the procedure of cleaning surface was shown as follows. The magnet was placed in the degreasing tank and was soaked for 10 min to remove the oil stain on the surface of the magnet. The surface was washed to clean with water, and then it was acid pickled with dilute HNO₃ for 30 s. Then it was washed with water again and was treated by ultrasonic wave for 30 s, and the surface of the magnet was quickly dried by strong wind, thereby obtaining aNdFeB magnet to be treated.

(3) In a argon atmosphere, the composite powder prepared in step (1) was carried with positive electrons by a spray gun according to technological conditions that a voltage was 70 kV, a time was 25 s, a moving speed of the spray gun was 18 cm/s and a spray distance was 22 cm. It was accelerated and impacted onto the NdFeB magnet to be treated obtained in step (2) which was connected to the cathode, thereby obtaining a NdFeB magnet with composite powder film adhered to the surface thereof, and the thickness of the film was about 30 μm.

(4) The NdFeB magnet with composite powder film adhered to the surface obtained in step (3) was placed in a vacuum thermal treatment furnace with a vacuum degree higher than 10⁻³ Pa and was maintained at 845° C. for 30 hours. It was cooled inside the furnace to not higher than 50° C., and then tempering treatment was performed at 490° C. for 6 hours.

(5) The magnet obtained in step (4) was soaked in dilute nitric acid (the concentration was 5.0 wt %) for 80 s to remove residual attachments on the surface of the magnet. The magnet was cleaned with deionized water to obtain a magnet with improved performance.

The coercivity of the rare earth permanent magnet material prepared in this example is increased by 8500 Oe, the remanence is slightly reduced and is reduced by 170 Gs. The performance variation of the magnet before and after the treatment are shown in Table 1.

TABLE 1
Performance test results of the magnets
before and after treatment in Eamples 1-9

| | | | Coercivity(kOe) | | Remanence (kGs) | |
|---|---|---|---|---|---|---|
| | Size of | | before | after | before | after |
| Example | permanent | | treat- | treat- | treat- | treat- |
| number | magnet | | ment | ment | ment | ment |
| Example 1 | 20*15*1.96 | mm | 17.74 | 31.98 | 13.96 | 13.77 |
| Example 2 | 25*15*3 | mm | 17.83 | 25.33 | 13.81 | 13.635 |
| Example 3 | 25*15*5 | mm | 13.28 | 25.28 | 13.32 | 13.14 |
| Example 4 | 25*15*3 | mm | 13.18 | 17.18 | 13.31 | 13.10 |
| Example 5 | 30*15*6 | mm | 20.20 | 31.20 | 14.20 | 14.032 |
| Example 6 | 25*15*3 | mm | 15.9 | 20.1 | 11.83 | 11.622 |
| Example 7 | 35*15*8 | mm | 18.5 | 26.5 | 13.7 | 13.515 |
| Example 8 | 35*15*6 | mm | 13.45 | 19.95 | 13.2 | 13.01 |
| Example 9 | 35*15*4.5 | mm | 24.8 | 33.3 | 13.67 | 13.5 |

### EXAMPLES 10-13

Except that the thicknesses of the composite powder films were different from that in Example 2, the other technological parameters in Examples 10-13 were the same as those in Example 2. Wherein, the thickness of the composite powder film in Example 10 was about 12 μm, and the thickness of the composite powder film in Example 11 was about 20 μm. The thickness of the composite powder film in Example 12 was about 5 μm, and the thickness of the composite powder film in Example 13 was about 45 μm. The performance variation of the magnets before and after treatment were shown in Table 2.

### EXAMPLES 14-15

Except that the holding temperature and holding time in the vacuum thermal treatment were different from those in step (4) of Example 2, the other technological parameters in Examples 14-15 were the same as those in Example 2. Wherein, the conditions of vacuum thermal treatment were 1000° C. for 10 h, the conditions of the vacuum thermal treatment in Example 15 were 700° C. for 48 h. The performance variation of the magnets before and after treatment were shown in Table 2.

### EXAMPLES 16-17

Except that the temperature and time of tempering treatment in step (4) were different from those in Example 2, the other technological parameters in Examples 16-17 were the same as those in Example 2. Wherein, the conditions of the tempering treatment in Example 16 were 430° C. for 8 h. The conditions of the tempering treatment in Example 17 were 640° C. for 2 h. The performance variation of the magnets before and after treatment were shown in Table 2.

TABLE 2
Performance test results of the magnets before
and after treatment in Examples 10-17

| | | Coercivity (kOe) | | Remanence (kGs) | |
|---|---|---|---|---|---|
| | Size of | before | after | before | after |
| Example | permanent | treat- | treat- | treat- | treat- |
| number | magnet | ment | ment | ment | ment |
| Example 10 | 25*15*3 mm | 17.83 | 20.33 | 13.81 | 13.75 |
| Example 11 | 25*15*3 mm | 17.83 | 22.83 | 13.81 | 13.69 |
| Example 12 | 25*15*3 mm | 17.83 | 19.02 | 13.81 | 13.78 |
| Example 13 | 25*15*3 mm | 17.83 | 25.43 | 13.81 | 13.61 |
| Example 14 | 25*15*3 mm | 17.83 | 24.80 | 13.81 | 13.55 |
| Example 15 | 25*15*3 mm | 17.83 | 20.51 | 13.81 | 13.76 |
| Example 16 | 25*15*3 mm | 17.83 | 24.30 | 13.81 | 13.64 |
| Example 17 | 25*15*3 mm | 17.83 | 23.84 | 13.81 | 13.63 |

### EXAMPLES 18-23

Except that the composition of the composite powder used were different from those in Example 2, the other technological parameters in Examples 18-23 were the same as those in Example 2; the specific composition of the composite powder and performance variation of the magnets before and after the treatment were shown in Table 3.

TABLE 3
Performance test results of the magnets before and after treatment in Examples 18-23

| | | Size of | Coercivity(kOe) | | Remanence (kGs) | |
|---|---|---|---|---|---|---|
| Example | composition of the | permanent | before | after | before | after |
| number | composite powder | magnet | treatment | treatment | treatment | treatment |
| Example 18 | (DyF₃)₅₀Nd₁₀Al₄₀ | 25*15*3 mm | 17.83 | 22.09 | 13.81 | 13.71 |
| Example 19 | (DyF₃)₅₅Nd₂₀Al₂₅ | 25*15*3 mm | 17.83 | 22.92 | 13.81 | 13.69 |
| Example 20 | (DyF₃)₈₅Nd₅Al₁₀ | 25*15*3 mm | 17.83 | 24.96 | 13.81 | 13.66 |
| Example 21 | (DyF₃)₇₀Nd₁₀Al₂₀ | 25*15*3 mm | 17.83 | 23.61 | 13.81 | 13.68 |
| Example 22 | (DyF₃)₈₃Nd₁₀Al₇ | 25*15*3 mm | 17.83 | 24.80 | 13.81 | 13.66 |
| Example 23 | (DyF₃)₇₅Nd₁₈Al₇ | 25*15*3 mm | 17.83 | 24.32 | 13.81 | 13.67 |

Obviously, the above-mentioned examples are merely given for clearly illustration, and are not intended to limit the embodiments. For those skilled in the art, variations or changes of other different forms may be made on the basis of the above-mentioned illustration. There is no need and no way to exhaust all of the embodiments. Obvious variations or changes resulting therefrom are still within the protection scope of the present invention.

1. A method for preparing rare earth permanent magnet material comprising:
step 1, weighing powders of three raw materials, H, M and Q according to the atomic percentage content in a general formula H_{100-x-y}MₓQ_{y}, and performing the mixing treatment and sieving treatment sequentially on the three raw materials in a nitrogen gas or other oxygen-free environments to obtain a composite powder; wherein: in the general formula, H is one or more in fluoride or oxide powders of Dy, Tb, DyTb, Ho and Gd, M is Nd or/and Pr metal powder(s), and Q is one or more in Cu, Al, Zn, Ga and Sn metal powders, x and y are respectively the atomic percentage contents of the raw material M and the raw material Q, x=0-20, y=0-40, and x and y are not zero at the same time;
step 2, machining a sintered NdFeB magnet into a prescribed shape and size, and then performing the surface cleaning and drying to obtain a NdFeB magnet to be treated;
step 3, adhering the composite powder to the surface of the NdFeB magnet to be treated by static electricity in an oxygen-free environment to obtain a NdFeB magnet, the surface of which is adhered with a composite powder film.
step 4, performing vacuum thermal treatment on the NdFeB magnet, the surface of which is adhered with a composite powder film, and then furnace cooling to obtain a diffused NdFeB magnet.
step 5, performing tempering treatment on the diffused NdFeB magnet to obtain the rare earth permanent magnet material.

2. The method for preparing rare earth permanent magnet material according to claim 1, wherein: in the step 1, x is 1-15, y is 4-25 in the general formula.

3. The method for preparing rare earth permanent magnet material according to claim 1, wherein: in the step 1, M is PrNd metal powder, and the mass ratio of Pr and Nd is 1:2-1:5.

4. The method for preparing rare earth permanent magnet material according to claim 1, wherein: in the step 1, the raw material powders have a particle size of −150 mesh, and the sieving treatment means sieving with a 150 mesh sieve.

5. The method for preparing rare earth permanent magnet material according to claim 1, wherein: in the step 2, the thickness of the NdFeB magnet to be treated in direction of orientation is 1-8 mm.

6. The method for preparing rare earth permanent magnet material according to claim 1, wherein: in the step 3, the thickness of the composite powder film is 10-40 μm.

7. The method for preparing rare earth permanent magnet material according to claim 1, wherein: in the step 3, the composite powder is sprayed onto the surface of the NdFeB magnet to be treated by an electrostatic spray gun; in which, technological conditions are as follows:
the voltage is 30-120 kv;
the time is 5-40 s;
the movement speed of the spray gun is 5-45 cm/s;
the spray distance is 8-35 cm.

8. The method for preparing rare earth permanent magnet material according to claim 1, wherein: in the step 4, the conditions of the vacuum thermal treatment are as follows: the vacuum degree is higher than 10⁻³ Pa, the holding temperature is 650-1050° C., and the holding time is 5-50 h.

9. The method for preparing rare earth permanent magnet material according to claim 8, wherein: the holding temperature is 830-870° C., and the holding time is 30-40 h; the furnace cooling is performed until the temperature is no more than 50° C.

10. The method for preparing rare earth permanent magnet material according to claim 1, wherein: in the step 5, the temperature of the tempering treatment is 420-640° C., the time thereof is 2-10 h.

11. The method for preparing rare earth permanent magnet material according to claim 10, wherein: the temperature of the tempering treatment is 420-480° C., the time is 4-6 h.

12. The method for preparing rare earth permanent magnet material according to claim 1, wherein: an aftertreatment step after the step 5 is further included, comprising: soaking the rare earth permanent magnet material in dilute nitric acid to remove residual attachments on the surface thereof, and then cleaning the rare earth permanent magnet material with a deionized water.

13. The method for preparing rare earth permanent magnet material according to claim 12, wherein: the dilute nitric acid is a solution of nitric acid in alcohol, the mass concentration is 2-10%, and the time of the soaking is 60-180 s.

14. The method for preparing rare earth permanent magnet material according to claim 13, wherein: the mass concentration of the solution of nitric acid in alcohol is 4-6%.

15. The method for preparing rare earth permanent magnet material according to claim 1, wherein: the procedure of the surface cleaning is as follows: firstly placing the sintered NdFeB magnet in a degreasing tank and soaking for 8-15 minutes to remove oil stain on the surface of the magnet; then performing the first water washing, acid pickling, the second water washing and ultrasonic treatment sequentially, finally, air drying the surface of the sintered NdFeB magnet; the acid pickling is performed with a dilute HNO₃ and the time thereof is 20-45 s, and the time of the ultrasonic treatment is 20-45 s, the air drying is fast drying using strong wind.

16. The method for preparing rare earth permanent magnet material according to claim 6, wherein: the thickness of the composite powder film is 25-40 μm.

17. The method for preparing rare earth permanent magnet material according to claim 7, wherein: the voltage is 50-90 kv in the step 3.

18. The method for preparing rare earth permanent magnet material according to claim 7, wherein: the time is 15-30 s in the step 3.

19. The method for preparing rare earth permanent magnet material according to claim 7, wherein: the movement speed of the spray gun is 10-30 cm/s in the step 3.

20. The method for preparing rare earth permanent magnet material according to claim 7, wherein: the spray distance is 15-25 cm in the step 3.
